(19) United States
(12) Patent Application Publication
(10) Pub. No.: US 2026/0220954 A1
(43) Pub. Date: Jul. 30, 2026

(54) Assigning temporal labels to video frames based on time metadata superimposed on the video images

(71) Applicant: FLYMINGO INNOVATIONS LTD., Kiryat Ono (IL)

(72) Inventors: Itzik Mizrahi, Maccabim-Re’ut (IL); Gal Fiebelman, Manof (IL)

(21) Appl. No.: 19/144,966

(22) PCT Filed: Nov. 20, 2023
(86) PCT No.: PCT/IB2023/061684

§ 371 Date: Jul. 1, 2025

Related U.S. Application Data
(60) Provisional application No. 63/478,190, filed on Jan. 3, 2023.

(51) Int. Cl. G06V 20/70; H04N 21/43; H04N 21/8547

(52) U.S. Cl. CPC G06V 20/70; H04N 21/4307; H04N 21/8547

(57) ABSTRACT

A method for video processing includes receiving a sequence of video frames containing video images having respective timestamps with a first temporal granularity superimposed on the video images (100). The video frames are processed to extract numerical values of the timestamps from the video images (104). Transitions are identified in the numerical values within the sequence (108), and responsively to the transitions, temporal labels are assigned to the video frames with a second temporal granularity that is finer than the first temporal granularity (112).

### CROSS-REFERENCE TO RELATED APPLICATIONS

This application claims the benefit of U.S. Provisional Patent Application 63/478,190, filed Jan. 3, 2023, whose disclosure is incorporated herein by reference.

### TECHNICAL FIELD

Embodiments described herein relate generally to video processing, and particularly to methods and systems for assigning temporal labels to video frames based on time metadata superimposed visually on corresponding video images.

### BACKGROUND

In various applications video clips containing sequences of video frames are captured using video sensors such as a network camera. The video clips are typically stored for later processing analysis and viewing.

Techniques for managing the capture and storage of video clips are known in the art. For example, U.S. Pat. No. 9,161,003 describes a time synchronization apparatus and method for a network camera and a network video recorder (NVR) connected to the network camera. The apparatus includes: a data receiving unit receiving a data stream from the network camera, the data stream including timestamp information of the network camera; a noise determining unit determining whether time information input from the network camera is a noise based on a timestamp of the network camera contained in the timestamp information; and a setting control unit setting a timestamp of the NVR based on the determining of the noise determining unit, wherein the data stream comprises data obtained by the network camera and the timestamp information of the network camera which indicates a time when the data stream was transmitted from the network camera.

As another example, U.S. Pat. No. 10,764,473 describes systems, methods and computer program products to perform an operation comprising receiving a first video frame specifying a first timestamp from a first video source, receiving a second video frame specifying a second timestamp from a second video source, wherein the first and second timestamps are based on a remote time source, determining, based on a local time source, that the first timestamp is later in time than the second timestamp, and storing the first video frame in a buffer for alignment with a third video frame from the second video source.

### SUMMARY

An embodiment that is described herein provides a method for video processing, including receiving a sequence of video frames containing video images having respective timestamps with a first temporal granularity superimposed on the video images. The video frames are processed to extract numerical values of the timestamps from the video images. Transitions are identified in the numerical values within the sequence, and responsively to the transitions, temporal labels are assigned to the video frames with a second temporal granularity that is finer than the first temporal granularity.

In some embodiments, the first temporal granularity is in seconds, and the second temporal granularity is in units not greater than one thousandth of a second. In other embodiments, the second temporal granularity is such that each frame has a unique, respective temporal label. In yet other embodiments, receiving the sequence of video frames includes receiving multiple, unsynchronized sequences from multiple different video sources, and the method includes synchronizing the multiple sequences using the temporal labels.

In an embodiment, the video sources include network cameras. In another embodiment, receiving the sequence of video frames includes receiving the sequence of video frames over a communication network. In yet another embodiment, the method further includes storing the video frames labeled with the temporal labels having the second temporal granularity to a storage medium.

In some embodiments, identifying the transitions includes identifying the transitions in one-second intervals. In other embodiments, the method includes calculating a frame per seconds (FPS) value by counting a number of video frames between two or more successive transitions.

There is additionally provided, in accordance with an embodiment that is described herein, an apparatus for video processing, including and interface and a processor. The interface is configured to receive a sequence of video frames containing video images having respective timestamps with a first temporal granularity superimposed on the video images. The processor is configured to process the video frames to extract numerical values of the timestamps from the video images, to identify transitions in the numerical values within the sequence, and responsively to the transitions, to assign temporal labels to the video frames with a second temporal granularity that is finer than the first temporal granularity.

There is additionally provided, in accordance with an embodiment that is described herein, a computer software product, including a non-transitory computer-readable medium in which program instructions are stored, which instructions, when read by a computer cause the computer to receive a sequence of video frames containing video images having respective timestamps with a first temporal granularity superimposed on the video images, to process the video frames to extract numerical values of the timestamps from the video images, to identify transitions in the numerical values within the sequence, and responsively to the transitions, to assign temporal labels to the video frames with a second temporal granularity that is finer than the first temporal granularity.

These and other embodiments will be more fully understood from the following detailed description of the embodiments thereof, taken together with the drawings in which:

### BRIEF DESCRIPTION OF THE DRAWINGS

FIG. 1 is a block diagram that schematically illustrates a system for video processing, in accordance with an embodiment that is described herein;

FIG. 2 is a diagram that schematically illustrates a sequence of video images on which time metadata is superimposed, in accordance with an embodiment that is described herein;

FIG. 3 is a flow chart that schematically illustrates a method for assigning fine granularity temporal labels to video frames, in accordance with an embodiment that is described herein;

FIG. 4 is a flow chart that schematically illustrates a method for extracting a numerical value of a timestamp superimposed on a video frame, in accordance with an embodiment that is described herein; and

FIGS. 5A and 5B are diagrams that schematically illustrate methods for assigning temporal labels to video frames at a fine temporal granularity, in accordance with embodiments that are described herein.

### DETAILED DESCRIPTION OF EMBODIMENTS

### Overview

Various video-based applications involve the capture of video clips originating from multiple video sources simultaneously. The captured video clips are typically sent, e.g., over a communication network, for storage in a storage medium for later viewing and processing. Each video clip comprises a sequence of video frames containing video images. Video-based applications sometimes require accessing segments of one or more video clips with high temporal precision, e.g., for the purpose of synchronizing among multiple video clips originating from different sources. Relevant video-based applications include (but not limited to) surveillance, sports, automatic production, and activity monitoring, to name a few.

In the present context, synchronizing among multiple video clips (or frames) means that video frames of different video clips that were captured simultaneously (in accordance with a common time reference) should be assigned the same temporal labels (or approximately the same temporal labels within a predefined timing error).

A video processing server receiving sequences of synchronized video frames from different sources may lose synchronization for various reasons, such as the server type, the communication system connecting between the video sources and server, the types of cameras used, and the like. Consequently, video frames originating synchronously from different sources may be subjected to different respective delays at the server side, falsely causing the assignment of different respective temporal labels to simultaneous video frames.

In the disclosed embodiments, a video processing server receives a sequence of video frames containing video images on which timestamps are superimposed visually. For example, a network camera (or another video source) may superimpose the visual timestamps in a HH:MM:SS format, wherein ‘HH’ denotes an hour count, ‘MM’ denotes a minutes count, and ‘SS’ denotes a seconds count. In this format, time information at granularity finer than seconds is omitted or truncated.

In some embodiments, the video processing sever implements a method for video processing, including: receiving a sequence of video frames containing video images having respective timestamps with a first temporal granularity superimposed on the video images, processing the video frames to extract numerical values of the timestamps from the video images, identifying transitions in the numerical values within the sequence, and responsively to the transitions, assigning temporal labels to the video frames with a second temporal granularity that is finer than the first temporal granularity.

The sequence of video frames may be received in the server over a communication network. Depending on the underlying application, various types of video sources may be used, such as, for example, network cameras.

In implementing the method, various temporal granularity units may be used, e.g., in an embodiment, the first (course) temporal granularity is in units of seconds and the second (finer) temporal granularity is in units not greater than one thousandth of a second (one millisecond). The second temporal granularity is set such that each of the video frames has a unique, respective temporal label.

In some embodiments the sequence of video frames includes multiple, unsynchronized sequences originating from multiple different video sources, and the method includes synchronizing the multiple sequences using the temporal labels having the second temporal granularity.

In some embodiments the method includes storing the video frames labeled with the temporal labels having the second temporal granularity to a storage medium.

The transitions may be detected in various ways, e.g., within one-second intervals. The one-second interval may include the first and/or last one-second interval of the video clip. More generally, the one-second interval may be aligned to an integer multiple of one-second intervals starting at the beginning or end of the video clip. Some one-second intervals may be identified by detecting consecutive transition events.

In the disclosed techniques, numerical values of timestamps are extracted from visual timestamps superimposed on video images. Transitions of the numerical values are detected and used for assigning to video frames temporal labels having fine temporal granularity such that each video frame is assigned a unique temporal label. The temporal labels having the fine temporal granularity may be used for high-precision synchronization between video sequences originating from different sources.

### System Description

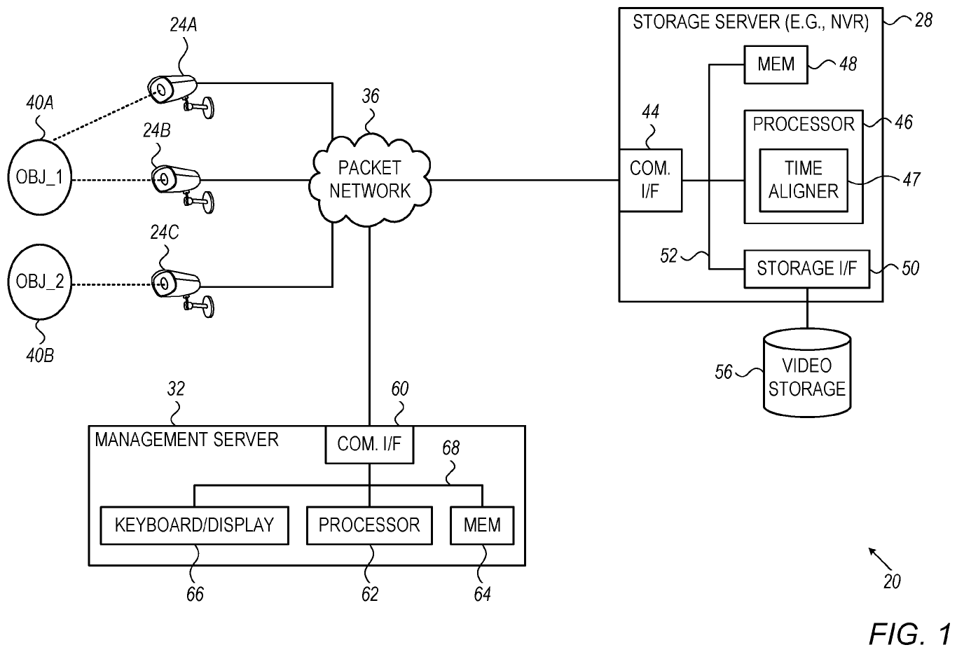

FIG. 1 is a block diagram that schematically illustrates a system 20 for video processing, in accordance with an embodiment that is described herein.

System 20 comprises video sources 24A, 24B and 24C, a storage server 28 and a management server 32. In the example of system 20 the video sources, storage server and management server communicate with one another over a communication network 36. The video sources are collectively identified as numbered 24. In alternative embodiments, however, the video sources may be connected to the storage server using other suitable interfaces (not shown).

Video sources 24A-24C provide sequences of video frames in digital form, wherein the video frames containing video images. In the present example, the video sources comprise video sensors such as network cameras (also referred to as IP cameras). Alternatively, other suitable video sources can also be used. The network cameras capture video images of objects in the scene and send sequences of the video frames containing the captured video images, e.g., for storage in storage server 28. In the example of system 20, cameras 24A and 24B are 30 directed to a common object 40A, whereas camera 24C is directed to another object 40B. In alternative embodiments, system 20 may comprise a single video sensor (e.g., 24A) or any other suitable number of video sensors other than three, directed to any suitable number of objects.

System 20 may be used in various applications such as surveillance and security systems, entertainment and sports, production management, warehouse management, activity monitoring, and the like.

Communication network 36 may comprise any suitable packet network operating in accordance with any suitable communication protocols. For example, communication network 36 may comprise an IP network or an Ethernet network. As another example, the communication network may comprise a land network, a wireless network or a combination of land and wireless networks. Example streaming protocols applicable in communication network 36 for receiving video clips may include, for example, the Real Time Streaming Protocol (RTSP) or the Open Network Video Interface Forum (ONVIF) protocol. An example protocol for accessing storage server 28 over the communication network is the Hypertext Transfer Protocol (HTTP).

Storage server 28 receives sequences of video frames from video sources 24 for storge. The storage server comprises a communication interface 44 coupled to the communication network, a processor 46, a memory 48 and a storage interface 50. The various elements of the storage server communicate with one another over any suitable link or bus 52 such, for example, a peripheral component interconnect express (PCIe) bus.

Communication interface 44 supports communication between communication network 36 and the storage server. The communication interface may comprise, for example, a network interface controller (NIC) or any other suitable type of a communication interface. In some embodiments, processor 46 implements a time aligner 47 for processing video images of video frames received from the video sources over the communication network, to determine accurate unique temporal labels for the video frames. Methods for such processing will be described in detail below. In some embodiments, processor 46 runs instructions of software program(s) stored in memory 48, such as an operating system and various application programs, e.g., time aligner 47.

Storage interface 50 interfaces between the storage server and a storage medium 56. The processor stores video frames of video clips in the storage medium and retrieves video frames previously stored via the storage interface. The storage medium may comprise a memory of any suitable storage technology and size, such as, for example, a disk drive, a universal serial bus (USB) flash drive, a secure digital (SD) memory card or a mass storage device of other types.

Management server 32 manages the storage, retrieval, and processing of video clips captured or otherwise provided by video sensors 24. Management server 32 comprises a communication interface 60, a processor 62, a memory 64 and a user interface 66. The various elements of the management server communicate with one another over any suitable link or bus 68 such as, for example, a PCIe bus.

In some embodiments, processor 62 runs instructions of software program(s) stored in memory 64, such as an operating system and various application programs, e.g., a program for analyzing video clips. For example, processor 62 orchestrates the operation of system 20, e.g., under the control of a user via user interface 66 comprising elements such as, for example, a keyboard and a display.

The management server may control (via processor 62) the operation of video sources (e.g., cameras) 24 by setting various operational camera parameters such as a view angle, dimensions and pixel resolution of the video images, frame rate, exposure time, encoding and formatting of the video frames, and the like. In some embodiments, the management server additionally controls the scheduling of video capture by the network cameras. The management server also controls the operation of the storage server. For example, the management server may send to the storage server a command for retrieving from the storage medium one or more video frames of a given video clip, e.g., starting at a certain time instance.

In some embodiments, network cameras 24 are configured to generate video frames in synchronization with one another. In such embodiments multiple cameras capture respective video images simultaneously (e.g., within a predefined timing error). The different cameras may be synchronized to a common clock or time reference, e.g., using a time synchronization protocol such as, for example, the network time protocol (NTP).

The configurations of video sources 24, communication network 36, storage server 28 and management server 32 of system 20 in FIG. 1 are example configurations, which are chosen purely for the sake of conceptual clarity. In alternative embodiments, any other suitable video sources, communication network, storage server and management server configurations can also be used. The different elements of storage server 28 and of management server 32 may be implemented in hardware, such as using one or more Application-Specific Integrated Circuits (ASICs) or Field-Programmable Gate Arrays (FPGAs). In alternative embodiments, some elements of processors 46 and 62, e.g., time aligner 47 of processor 46, may be implemented in software executing on a suitable processor, or using a combination of hardware and software elements.

Elements that are not necessary for understanding the principles of the present application, such as various interfaces, addressing circuits, timing and sequencing circuits and debugging circuits, have been omitted from FIG. 1 for clarity.

In some embodiments, processor 46 and processor 62 may comprise general-purpose processors, which are programmed in software to carry out the storage server and management server functions described herein. The software may be downloaded to the processors in electronic form, over a network, for example, or it may, alternatively or additionally, be provided and/or stored on non-transitory tangible media, such as magnetic, optical, or electronic memory.

Although system 20 comprises separate storage server and management server, this configuration is not mandatory. In other embodiments, the functionality of the storage server and management server can be implemented in a common physical server. In alternative embodiments, the functionalities of storage server and/or management server may be divided over two or more servers in any suitable division manner.

Memories 48 and 64 may comprise storage devices of any suitable storage technology and size. For example, each of memories 48 and 64 may comprise one (or a combination of some) of: a Flash memory device, a random access memory (RAM) such as a double data rate synchronous dynamic RAM (DDR SDRAM), and the like.

### Timestamps Superimposed Over Video Images

In various video-based applications, timestamps are superimposed visually on the video images. Visual timestamps are applicable, for example, in as surveillance and sports, in which temporal granularity of seconds is typically sufficient. Other applications such as automatic production management and activity monitoring, however, typically require temporal granularity finer than seconds, e.g., temporal granularity not greater than one thousandth of a second (one millisecond).

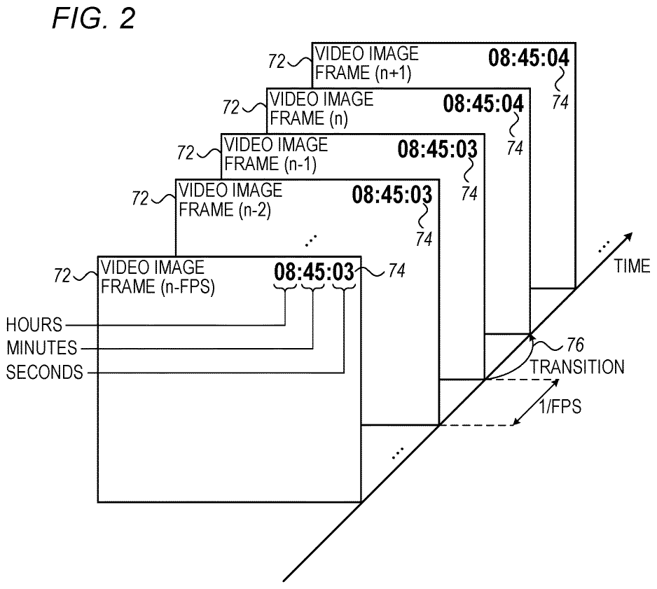

FIG. 2 is a diagram that schematically illustrates a sequence of video images 72 on which time metadata 74 is superimposed, in accordance with an embodiment that is described herein. In the example of FIG. 2 the video images belong to video frames indexed from Frame(n−FPS) to Frame(n+1), wherein “FPS” denotes a frame rate parameter (in units of frames per second), and ‘n’ denotes the nt frame of the underlying video clip.

In the present example, the metadata superimposed on video frames 72 comprises strings of digits in a HH:MM:SS format. Alternatively, the metadata may present the visual timestamps in any other suitable format, and possibly include additional information other than the timestamp. In the HH:MM:SS format, ‘HH’ denotes a two-digit hour count, ‘MM’ denotes a two-digit minutes count, and ‘SS’ denotes a two-digit seconds count of the frame current time. In the example of FIG. 2, the hour count is given by HH=08, the minutes count is given by MM=45, and the seconds count is given by SS=03 or SS=04.

For video frames belonging to the same video clip, the superimposed timestamps comprise digit images drawn from a common collection of digit images. Moreover, the digit images are placed on the same (or approximately the same) positions of the video image area across the video images. In general, different video sources may be associated with different sets of digit images and positions of the digit images on the video image.

The video clip is typically associated with a frame rate given in units of frames per second (FPS). The time interval between consecutive video frames is given by (1/FPS). The FPS value may be used for displaying the video frames at a desired rate. The FPS value may be set to 25 frames per second, for example, or to any other suitable number of frames per second.

The number of video frames within a one-second interval equals the FPS value. Consequently, the numerical value of the superimposed timestamps remains the same over a number of FPS consecutive frames before being changed. In the example of FIG. 2, a sequence of FPS consecutive frames having the same timestamp 08:45:03 starts at Frame(n−FPS) and ends at Frame(n−1). In moving to the subsequent Frame(n), the timestamp changes from 08:45:03 to 08:45:04. In the present context and in the claims, the term “transition” refers to an event in which the superimposed timestamp (or its numerical value) changes between two consecutive video frames. In the example of FIG. 2, a transition event 76 occurs between Frame(n−1) and Frame(n).

As will be described below, a transition (e.g., 76) may be detected and used for assigning unique temporal labels to the video frames, at a temporal granularity that is finer than the temporal granularity of the visually superimposed timestamps. Assignment of this sort relies on extracting numerical values from the superimposed timestamps, as will be described below.

### Assigning Fine Granularity Temporal Labels to Video Frames

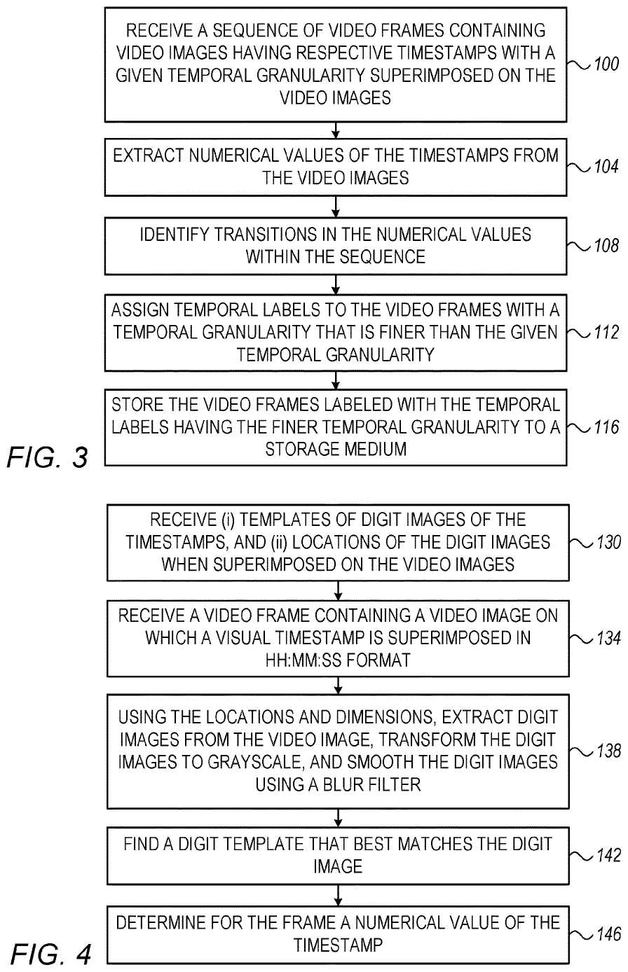

FIG. 3 is a flow chart that schematically illustrates a method for assigning fine granularity temporal labels to video frames, in accordance with an embodiment that is described herein. The method will be described as executed by processor 46 of storage server 28 of FIG. 1 (e.g., by using time aligner 47).

The method begins at a reception step 100, with processor 46 receiving a sequence of video frames containing video images having respective timestamps with a given temporal granularity superimposed on the video images. In the present example, the given temporal granularity is specified in units of seconds, and the superimposed timestamps are given in the HH:MM:SS format, as described above.

At an extraction step 104, the processor extracts numerical values of the timestamps from the video images (or from a partial subset of the video frames). Methods for implementing step 104 will be described with reference to FIG. 4 below. At a transition identification step 108 the processor identifies transitions in the numerical values within the sequence. For example, the processor may identify a transition occurring in the first and/or last one-second interval of the video clip.

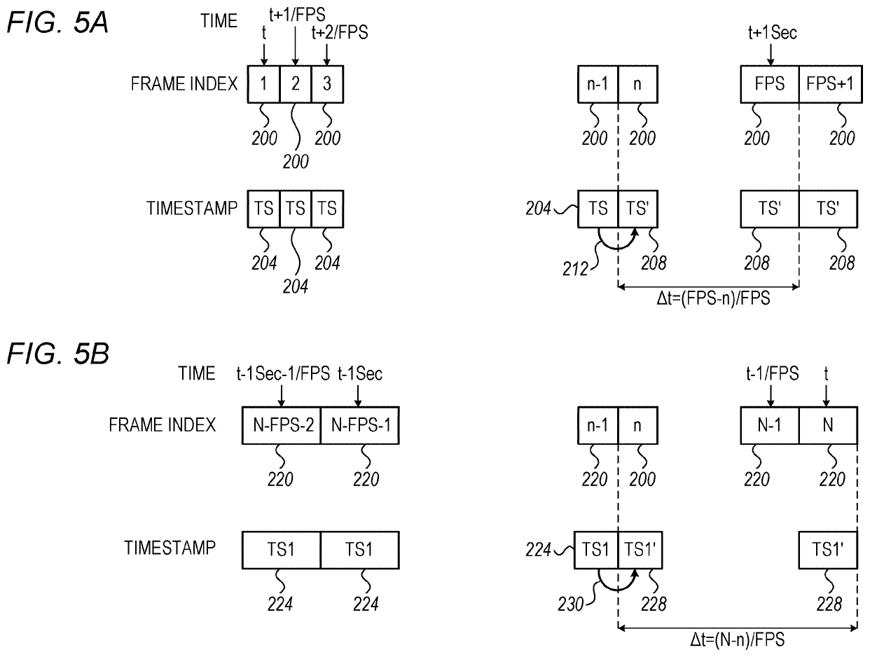

At a temporal labels assignment 112, the processor assigns temporal labels to the video frames with a temporal granularity that is finer than the given temporal granularity. For example, the given (coarse) temporal granularity may be in units of seconds, as noted above, whereas the finer temporal granularity may be specified in units not greater than one thousandth of a second (one millisecond). Methods for implementing step 112 will be described in detail with reference to FIGS. 5A and 5B below.

At a storage step 116, the processor stores the video frames labeled with temporal labels having the finer temporal granularity to a storage medium. For example, the processor stores the video frames to storage medium 56 via storage interface 50.

Following step 116 the method terminates.

FIG. 4 is a flow chart that schematically illustrates a method for extracting a numerical value of a timestamp superimposed on a video frame, in accordance with an embodiment that is described herein.

The method will be described as executed by processor 46 of storage server 28 of FIG. 1. The method may be used, for example, in implementing step 104 of the method of FIG. 3 above.

The method begins at an initialization step 130, with processor 46 receiving (i) digit templates comprising digit images building the timestamps (in the range 0 . . . 9), and (ii) positions and dimensions of the digit images of the timestamp as superimposed on the video images. Each of the digit templates is associated with a respective numerical digit value. The positions may be specified as horizontal and vertical positions on the pixel grid of the video image, and the dimensions may specify the width and height of the digit image, in pixel units. As will be described further below, in some embodiments, the digit templates and positions/dimensions are contained in dictionaries built in a preprocessing stage.

At a video reception step 134, the processor receives a video frame containing a video image on which a visual timestamp is superimposed. In the present example, the timestamp is presented in the HH:MM:SS format.

At an extraction preprocessing step 138, the processor uses the positions and dimensions received at step 130 for extracting digit images of the timestamp from the video image. Further at step 138, the processor transforms the digit images to grayscale, and applies to each grayscale digit image any suitable smoothing or blur filter to produce a blurred digit image. The blur filter may comprise, for example, a Gaussian blur filter.

At a matching step 142, for each blurred digit image, the processor finds, among the digit templates, a digit template that best matches the blurred digit image. For example, the processor calculates a correlation function between the blurred digit image and each of the digit templates and selects the digit template for which the output of the correlation function is maximized.

At a numerical value determination step 146, the processor determines for the video frame a numerical value of the timestamp, wherein the numerical value for each digit image of the timestamp is given by the numerical value associated with that digit template.

Following step 146 the method terminates.

FIGS. 5A and 5B are diagrams that schematically illustrate methods for assigning temporal labels to video frames at a fine temporal granularity, in accordance with embodiments that are described herein. The methods are based on detecting a transition occurring in the first or last one-second interval of the video clip. The video frames are associated with respective time instances, which may refer to the capture times or presentation times of the frames.

In describing FIGS. 5A and 5B it is assumed that the FPS value is known and does not change along the video frames. These assumptions may be relaxed in other embodiments, as will be described further below.

FIG. 5A depicts a sequence of video frames 200 of a video clip. In the present example, the sequence includes video frames between Frame(1) and Frame(FPS+1). Let ‘t’ denote a time instance associated with Frame(1). For example, ‘t’ may denote the ending time of presenting Frame(1). Subsequent frames are associated with respective times t+1/FPS, t+2/FPS, and so on. The frame whose index equals FPS is associated with the time instance t+1 Sec.

In the example of FIG. 5A, the first (n−1) frames contain video images on which the same timestamp 204 (denoted TS) is superimposed. On the video frames of the subsequent FPS frames a timestamp 208 (denoted TS′) is superimposed, wherein TS' is given by TS′=TS+1 Sec. In this example, a transition 212 occurs between Frame(n−1) and Frame(n), wherein n≤FPS.

In some embodiments, processor 46 detects the transition between Frame(n−1) and Frame(n) and translates the frame index ‘n’ to a unique accurate temporal label for Frame(n). In some embodiments, the processor detects the transition by scanning the video frames in any suitable order, while extracting numerical values of the timestamps superimposed on the video images of the scanned video frames, e.g., as described above. Using the numerical values of the timestamps, the processor identifies the transition as the event in which the timestamp or its numerical value changes. Given the transition location in the sequence, the processor calculates a time difference denoted ‘Δt’ as given by:

$$Δ t = ( FPS - n ) / FPS \qquad Equation 1$$

wherein 0≤Δt<1 sec is a fractional interval of a second, and assigns a temporal label to Frame(n) as given by:

$$t ( n ) = TS + 1 Sec - Δ t \qquad Equation 2$$

In some embodiments processor 46 multiplies the Δt value in Equation 1 by 1000 to produce a temporal label having a temporal granularity of one millisecond. In some embodiments, the processor assigns temporal labels to frames other than Frame(n) by adding or subtracting relevant multiples of (1/FPS) units relative to t(n).

FIG. 5B depicts a sequence of video frames 220 of a video clip having N frames. In live streaming N may denote the index of a selected frame along the video stream. In this example, the depicted sequence includes frames between Frame(N−FPS−2) and Frame(N). Let ‘t’ denote a time associated with the last frame, Frame(N). For example, ‘t’ may denote the ending time of presenting Frame(N). The preceding frames are associated with respective time instances t−1/FPS, t−2/FPS and so on. The frame whose index equals N−FPS−1 is associated with a time instance t−1 Sec.

In the example of FIG. 5B, video frames between Frame(N−FPS−2) and Frame(n−1) contain video images on which the same timestamp 224 (denoted TS1) is superimposed. On the video frames of the subsequent FPS frames a timestamp 228 (denoted TS1′) is superimposed, wherein TS1′=TS1+1 Sec. In this example, a transition 230 occurs between Frame(n−1) and Frame(n), wherein n≤FPS.

In some embodiments, processor 46 detects the transition between Frame(n−1) and Frame(n) and translates the frame index ‘n’ to an accurate temporal label for Frame(n). In some embodiments, the processor detects the transition by scanning the video frames in any suitable order, while extracting numerical values of the timestamps superimposed on the scanned video frames, e.g., as described above. Using the numerical values of the timestamps, the processor identifies the transition as the event in which the timestamp (or its numerical value) changes. Given the transition location in the sequence, the processor calculates a time difference Δt as given by:

$$Δ t = ( N - n ) / FPS \qquad Equation 3$$

wherein 0≤Δt<1 is a fractional interval of a second, and assigns a temporal label to Frame(n) as given by:

$$t ( n ) = TS {1}^{′} - Δ t \qquad Equation 4$$

In some embodiments processor 46 multiplies the Δt value in Equation 3 by 1000 to produce a temporal label having a temporal granularity of one millisecond. In some embodiments, the processor assigns temporal labels to frames other than Frame(n) by adding or subtracting relevant multiples of (1/FPS) units relative to t(n).

The methods of FIGS. 5A and 5B are given by way of example, and other suitable methods can also be used. For example, in some embodiments, processor 46 detects a transition event by detecting that the rightmost seconds digit of the HH:MM:SS format changes between successive video frames. In such embodiments, the processor may extract from the video images only the low significance digit in the ‘SS’ part of the HH:MM:SS format. In an example embodiment, processor 46 carries out the methods of FIGS. 5A and 5B in two stages. In the first stage the processor extracts the low significant seconds digit from multiple frames, and in the second stage the processor scans the extracted seconds digits across multiple video frames to detect the transition.

In the examples of FIGS. 5A and 5B above, the processor searches for a transition in the first or last one-second interval of the underlying video clip. In alternative embodiments, the processor may detect a transition in a one-second interval other than the first or last one-second intervals of the video clip, e.g., in a one-second interval starting or ending at a time instance that is an integer multiple of the one-second interval.

Applying the methods of FIGS. 5A and 5B results in a fine temporal granularity such that each frame has a unique, respective temporal label. In an embodiment, the processor receives multiple, unsynchronized sequences of video frames from multiple different video sources (e.g., network cameras 24 in system 20 of FIG. 1) and synchronizes the multiple sequences using the temporal labels.

In describing FIGS. 5A and 5B above it was assumed that the FPS value is known and does not change over time. In some cases, however, the FPS value may be unknown to the storage server, and/or the FPS value may change over time, e.g., due to packet loss over the communication network. In such embodiments, processor 46 may estimate the FPS value by counting the number of frames received between two or more successive transition events. In these embodiments, the processor may estimate the FPS value once, e.g., based on two successive transitions occurring within the first two seconds of the video clip. Alternatively, the processor may estimate the FPS value multiple times during the video clip. In such embodiments, assigning a time label to the transition frame and deriving time labels by adding or subtracting units of (1/FPS) relative to the transition time may be limited to some interval around the transition time, e.g., to the one-second interval containing the transition.

### Preprocessing Methods

In some embodiments, preprocessing methods are carried out to generate digit templates, and positions and dimensions of digit images when superimposed on video images. The methods may be carried out, for example, by processor 46 of system 20. Alternatively, the processing methods may be carried out by another processor external to the storage server. In some embodiments, applying the preprocessing methods involves receiving video frames of some reference video clip(s) whose video images contain superimposed timestamps. The video clip(s) may be captured, for example, by a given network camera 24 to be used later in system 20. In the present example, the timestamps are given in the HH:MM:SS format.

The processor analyzes the video images of the received frames to detect the positions of the image digits on the video images and the dimensions of the digit images. Based on this analysis, the processor generates a dictionary whose keys are the pixel position(s) of the digit images in the HH:MM:SS format. The value associated with each key in the dictionary specifies a bounding box of pixels surrounding the relevant digit image, e.g., the top left pixel coordinates and the width and height of the bounding box.

In some embodiments, the processor samples the digit images from the video images using the estimated bounding boxes. The processor transforms the digit images to grayscale images and compares the gray pixels to a specified brightness threshold to create a binary image in which the pixels of the digit are white, and the pixels of the background are black. Alternatively, brightness levels other than white and black can also be used. The processor saves the binary image as a value in another dictionary of template digits. The keys of this dictionary are the numerical digit values, and the corresponding values are the binary images serving as the digit templates.

The embodiments described above are given by way of example, and other suitable embodiments can also be used.

It will be appreciated that the embodiments described above are cited by way of example, and that the following claims are not limited to what has been particularly shown and described hereinabove. Rather, the scope includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method for video processing, comprising:
receiving a sequence of video frames containing video images having respective timestamps with a first temporal granularity superimposed on the video images;
processing the video frames to extract numerical values of the timestamps from the video images;
identifying transitions in the numerical values within the sequence; and
responsively to the transitions, assigning temporal labels to the video frames with a second temporal granularity that is finer than the first temporal granularity.

2. The method according to claim 1, wherein the first temporal granularity is in seconds, and the second temporal granularity is in units not greater than one thousandth of a second.

3. The method according to claim 1, wherein the second temporal granularity is such that each frame has a unique, respective temporal label.

4. The method according to claim 1, wherein receiving the sequence of video frames comprises receiving multiple, unsynchronized sequences from multiple different video sources, and wherein the method comprises synchronizing the multiple sequences using the temporal labels.

5. The method according to claim 4, wherein the video sources comprise network cameras.

6. The method according to claim 1, wherein receiving the sequence of video frames comprises receiving the sequence of video frames over a communication network.

7. The method according to claim 1, and comprising storing the video frames labeled with the temporal labels having the second temporal granularity to a storage medium.

8. The method according to claim 1, wherein identifying the transitions comprises identifying the transitions in one-second intervals.

9. The method according to claim 1, and comprising calculating a frames per seconds (FPS) value by counting a number of video frames between two or more successive transitions.

10. An apparatus for video processing, comprising:
an interface, configured to receive a sequence of video frames containing video images having respective timestamps with a first temporal granularity superimposed on the video images; and
a processor, configured to:
process the video frames to extract numerical values of the timestamps from the video images;
identify transitions in the numerical values within the sequence; and
responsively to the transitions, assign temporal labels to the video frames with a second temporal granularity that is finer than the first temporal granularity.

11. The apparatus according to claim 10, wherein the first temporal granularity is in seconds, and the second temporal granularity is in units not greater than one thousandth of a second.

12. The apparatus according to claim 10, wherein the second temporal granularity is such that each frame has a unique, respective temporal label.

13. The apparatus according to claim 10, wherein the processor is configured to receive the sequence of video frames by receiving multiple, unsynchronized sequences from multiple different video sources, and to synchronize the multiple sequences using the temporal labels.

14. The apparatus according to claim 13, wherein the video sources comprise network cameras.

15. The apparatus according to claim 10, wherein the processor is configured to receive the sequence of video frames over a communication network.

16. The apparatus according to claim 10, wherein the processor is configured to store the video frames labeled with the temporal labels having the second temporal granularity to a storage medium.

17. The apparatus according to claim 10, wherein the processor is configured to identify the transitions by identifying the transitions in one-second intervals.

18. The apparatus according to claim 10, wherein the processor is configured to calculate a frames per seconds (FPS) value by counting a number of video frames between successive transitions.

19. A computer software product, comprising a non-transitory computer-readable medium in which program instructions are stored, which instructions, when read by a computer cause the computer to receive a sequence of video frames containing video images having respective timestamps with a first temporal granularity superimposed on the video images, to process the video frames to extract numerical values of the timestamps from the video images, to identify transitions in the numerical values within the sequence, and responsively to the transitions, to assign temporal labels to the video frames with a second temporal granularity that is finer than the first temporal granularity.

20. The computer software product according to claim 19, wherein the first temporal granularity is in seconds, and the second temporal granularity is in units not greater than one thousandth of a second.
